(19) United States
(12) Patent Application Publication
(10) Pub. No.: US 2014/0087973 A1
(43) Pub. Date: Mar. 27, 2014

(54) INTEGRATED CARRIER FOR MICROFLUIDIC DEVICE

(71) Applicant: Fluidigm Corporation, South San Francisco, CA (US)

(72) Inventor: Yusuf D. Amin, Fairfield, CA (US)

(73) Assignee: Fluidigm Corporation, South San Francisco, CA (US)

(21) Appl. No.: 14/029,676

(22) Filed: Sep. 17, 2013

Related U.S. Application Data
(63) Continuation of application No. 12/867,607, filed on Oct. 21, 2010, now abandoned.
(60) Provisional application No. 61/030,887, filed on Feb. 22, 2008.
(60) Provisional application No. 61/045,578, filed on Apr. 16, 2008.

(51) Int. Cl. B01J 19/00

(52) U.S. Cl. CPC B01J 19/0046
USPC 506/39; 264/255

(57) ABSTRACT

An injection molding method of fabricating a carrier for holding a microfluidic device can form all of the desired features of such a carrier, including wells, channels and ports having smaller dimensions and greater density than previously achieved, while reducing or avoiding fracturing and the need for drilling the substrate to form certain features, in particular the ports. The carrier includes a substrate with a plurality of wells, each well defining a volume of between 0.1 μl and 100 μl; a plurality of channels within the substrate wherein each well is in fluid communication with at least one of the plurality of channels; a plurality of ports within the carrier substrate wherein each port is for coupling with regions in the carrier substrate adapted to receive fluids or pressure; and a receiving portion for receiving a microfluidic device and placing the microfluidic device in fluid communication with the plurality of wells. The carrier has a polymeric composition and/or an array of structural features achieved via the injection molding fabrication technique that enhance its performance and compatibility with existing instrumentation.

### CROSS-REFERENCE TO RELATED APPLICATIONS

This application is a continuation of U.S. application Ser. No. 12/867,607 titled INTEGRATED CARRIER FOR MICROFLUIDIC DEVICE, filed Oct. 21, 2010; which is a National Phase application under 35 U.S.C. 371 of PCT/US2009/034635, filed Feb. 20, 2009, titled INTEGRATED CARRIER FOR MICROFLUIDIC DEVICE; which claims priority from U.S. Provisional Patent Application No. 61/030,887 titled INTEGRATED CARRIER FOR MICROFLUIDIC DEVICE, filed Feb. 22, 2008; and 61/045,578 titled INTEGRATED CARRIER FOR MICROFLUIDIC DEVICE, filed Apr. 16, 2008; the disclosures of which are incorporated herein by reference in their entirety and for all purposes.

### BACKGROUND OF THE INVENTION

1. Field of the Invention

The present invention relates generally to microfluidics, in particular to a microfluidic device carrier and related apparatus and instrumentation.

2. Description of Related Art

Microfluidic devices are defined as devices having one or more fluidic pathways, often called channels, microchannels, trenches, or recesses, having a cross-sectional dimension below 1000 μm, and which offer benefits such as increased throughput and reduction of reaction volumes for chemical analyses.

One important application for microfluidic devices is screening for conditions that will cause a protein to form a crystal large enough for structural analysis. Conventional protein crystallization reactions have involved forming a mixture by manually pipetting together a solution containing a protein and a solution containing a protein crystallization reagent. Determining the correct conditions for formation a crystal large enough to be placed in line with an X-ray source for performance of X-ray diffraction studies has been a time-consuming trail and error process. Precious protein isolates are exceedingly limited in supply and need to be judiciously used while screening for the right crystallization conditions.

Microfluidic devices can be used to spare protein consumption during condition screening by reducing the volume of protein crystallization assays, while also increasing the number of experiments performed in parallel during the screen. However, interfacing microfluidic devices to macroscale systems, such as robotic liquid dispensing systems, has been challenging, often resulting in a loss of the number of reactions that can be carried out in parallel in a single microfluidic device.

### SUMMARY OF THE INVENTION

The present invention pertains generally to a carrier for a microfluidic device for interfacing the microfluidic device to macroscale systems. A microfluidic device carrier in accordance with the present invention incorporates one or more of a variety of aspects to which improved device performance is attributed.

The invention provides, in one aspect, a carrier for holding a microfluidic device. The carrier has a substrate with a plurality of wells, each well defining a volume of between 0.1 μl and 100 μl; a plurality of channels within the substrate wherein each well is in fluid communication with at least one of the plurality of channels; and a receiving portion for receiving a microfluidic device and placing the microfluidic device in fluid communication with the plurality of wells via the plurality of channels. The carrier substrate is made of an amorphous cyclo-olefin polymer having a tensile elongation at break of at least 10%, for example about 20%. A suitable polymer has dicyclopentadiene and 1,3 pentadiene as monomeric components.

Advantageously, it has been found that all of the desired features of such a carrier, including wells, channels and ports having smaller dimensions and greater density than previously achieved, can be successfully formed through an injection molding process. It is believed that this polymeric composition reduces or avoids fracturing and the need for drilling the substrate to form certain features, in particular the ports. Thus, according to another aspect, a method of fabricating a carrier for holding a microfluidic device is provided.

In another aspect, the carrier of the invention has a substrate with dimensions of no more than 150 mm length by 100 mm width (e.g., about 125 mm length by 85 mm width), each of the plurality of wells has a well opening with a center point, the plurality of wells is spatially arranged such that the center point to center point spacing is about 4.5 mm (in accordance with the SBS standard for 384-well plates), the plurality of wells are arranged in a plurality of rows, and the well rows are divided into a first well region and a second well region, each well region having 96 wells.

In another aspect, the carrier of the invention has a substrate in which the plurality of channels access the receiving portion for the microfluidic device substantially uniformly around the perimeter of the receiving portion.

In another aspect, the carrier of the invention has a substrate that also includes a pressure accumulator for providing fluid under pressure to the microfluidic device, wherein the pressure accumulator is in fluid communication with the receiving portion for the microfluidic device via a channel no more than 20 mm in length.

In another aspect, each of the wells of the carrier of the invention has a depth that is less than half of the height of the carrier.

Additional notable features related to these aspects of the invention include accumulators that are smaller and better positioned than in previous carrier designs; and smaller, more finely rendered and more densely arrayed wells, channels and ports.

In other embodiments, a microfluidic system is provided. An array device is provided for containing a plurality of separate reaction chambers disposed within a reaction area and in fluid communication with fluid inlets to the array device disposed outside the reaction area. The array device comprises an elastomeric block formed from a plurality of layers. At least one layer has at least one recess formed therein. The recess has at least one deflectable membrane integral to the layer with the recess. A carrier in accordance with the present invention is adapted to hold the array device and has a plurality of fluid channels interfaced with the fluid inlets. A thermal transfer interface comprises a thermally conductive material disposed to provide substantially homogeneous thermal communication from a thermal control source to the reaction area.

These and other aspects of the present invention are described in more detail in the description that follows.

### BRIEF DESCRIPTION OF THE DRAWINGS

FIGS. 1A-G are schematic illustrations of a microfluidic device carrier provided to illustrate some basic structure and features of a carrier in accordance with the present invention.

FIGS. 2A and B are perspective views of a station for actuating a microfluidic device in accordance with the present invention, shown in an open and closed position, respectively.

FIG. 3 is a simplified overall view of a system according to an embodiment of the present invention.

FIGS. 4A-I are schematic illustrations of a microfluidic device carrier in accordance with the present invention.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail so as to not unnecessarily obscure the present invention.

Introduction

The present invention relates generally to a microfluidic device carrier for interfacing the microfluidic device to macroscale systems, and related systems. Systems of the present invention will be particularly useful for metering small volumes of material in the context of performing a variety of chemical analyses, for example, crystallization screening of target material. A host of parameters can be varied during such a crystallization screening. Such parameters include but are not limited to: 1) volume of crystallization trial, 2) ratio of target solution to crystallization solution, 3) target concentration, 4) co-crystallization of the target with a secondary small or macromolecule, 5) hydration, 6) incubation time, 7) temperature, 8) pressure, 9) contact surfaces, 10) modifications to target molecules, 11) gravity, and (12) chemical variability. Volumes of crystallization trials can be of any conceivable value, from the picoliter to milliliter range.

Carriers and systems of the present invention will be particularly useful with various microfluidic devices, including without limitation the Topaz® series of devices available from Fluidigm Corporation of South San Francisco, Calif. The present invention also will be useful for microfabricated fluidic devices utilizing elastomer materials, including those described generally in U.S. patent application Ser. No. 11/740,735 filed Apr. 26, 2007 and entitled Integrated Chip Carriers with Thermocycler Interfaces and Methods of Using the Same (Publication No. US2007/0196912, published Aug. 23, 2007) and the applications from which it claims priority. These patent applications are hereby incorporated by reference herein in their entireties, particularly their general disclosure relating to the function of various components of microfluidic device carriers, including channels, pressure accumulators, check valves, etc.; their disclosure relating to components of a microfluidic system other than the carriers described herein, such as microfluidic devices, robotic stations, etc; and their disclosure relating to the fabrication of microfluidic device carriers by injection molding techniques which are adaptable for use in the fabrication of carriers in accordance with the present invention.

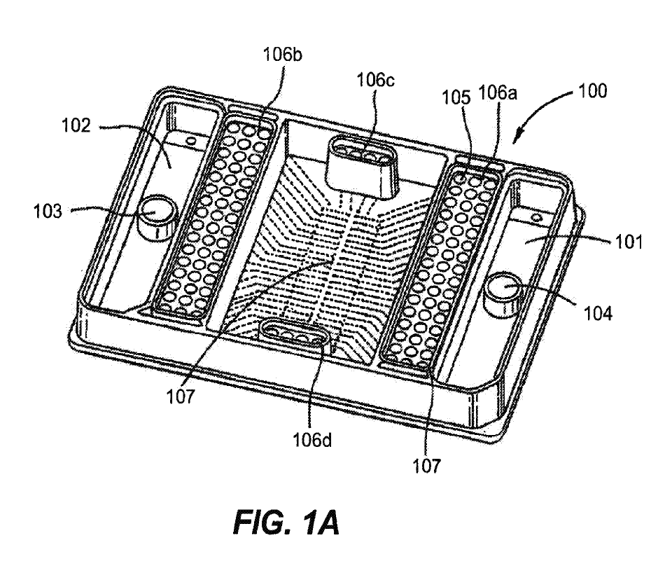

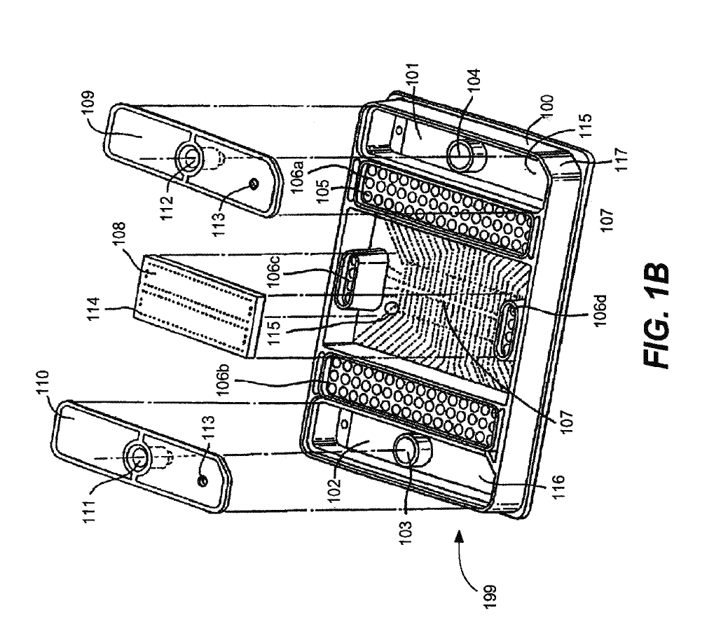

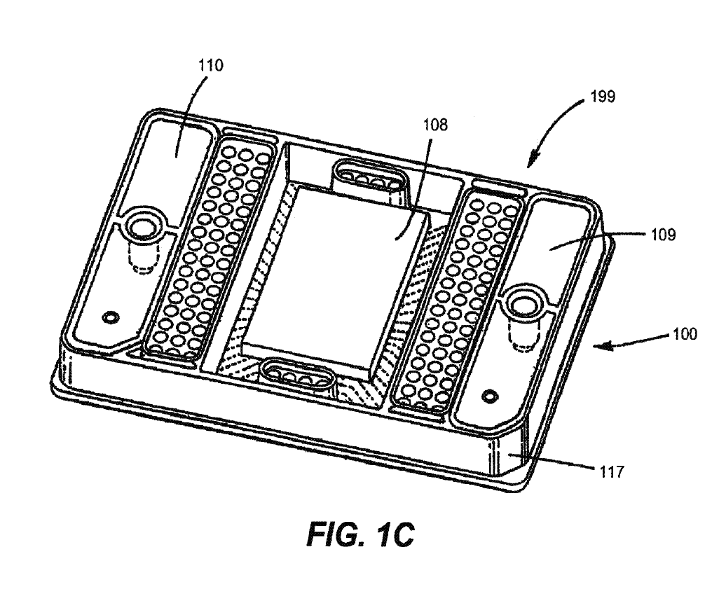

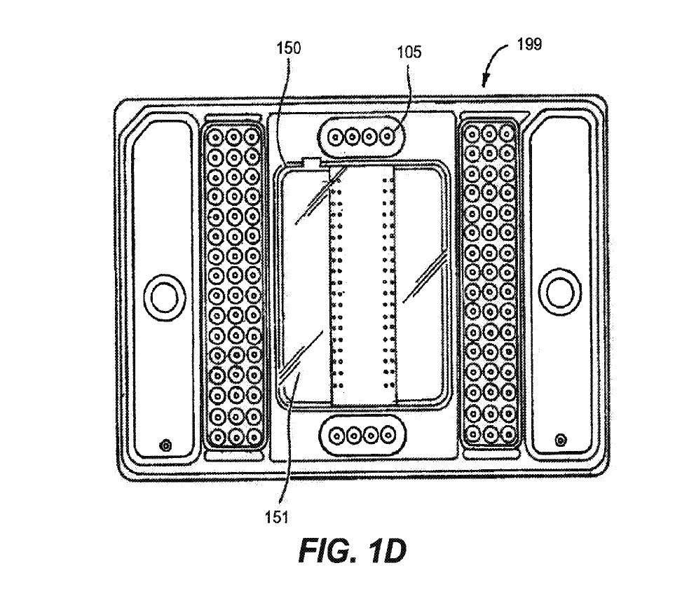

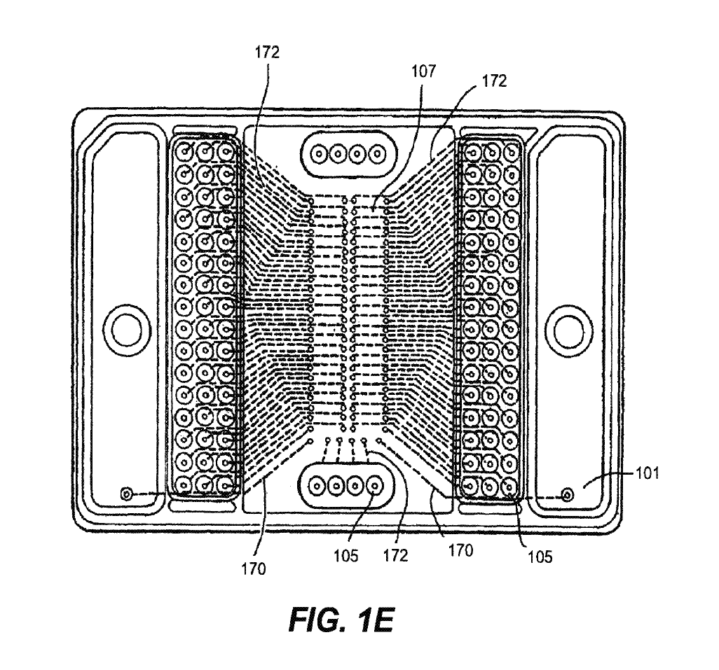

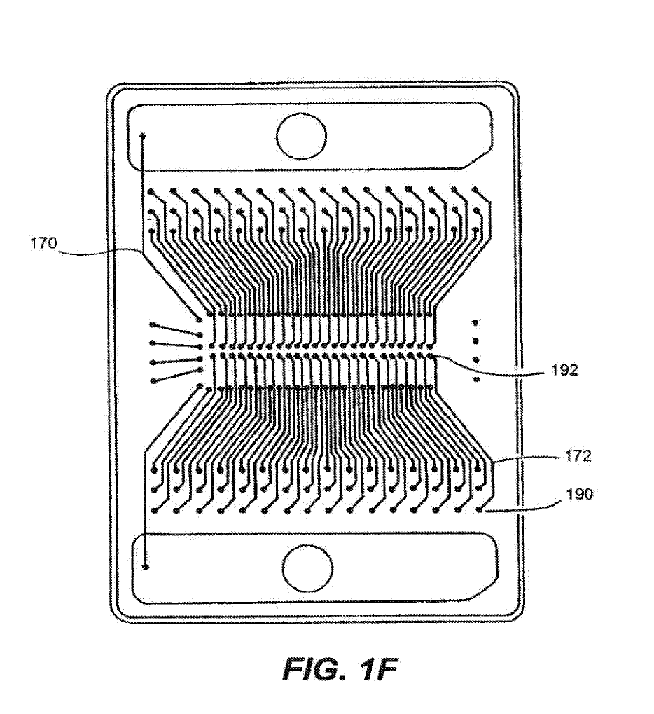

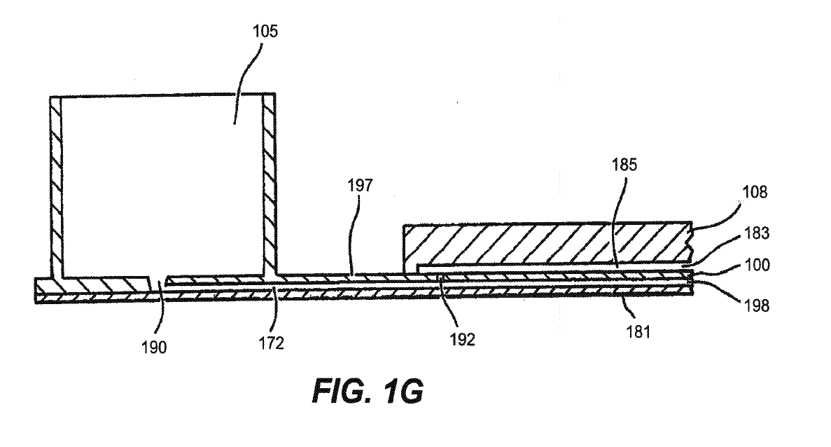

Turning now to FIGS. 1A-G, reference is made to a microfluidic device carrier in the general nature of a carrier in accordance with the present invention in order to provide an introduction to basic features of such a carrier. The particular carriers of the present invention, their advantageous features and associated systems are illustrated and described in subsequent figures and description following this introduction.

FIG. 1A illustrates a microfluidic device carrier substrate that has integrated pressure accumulator wells 101 and 102, each having therein a drywell 103, 104 for receiving a valve, preferably a check valve attached to a cover (see FIG. 1B). Substrate 100 further includes one or more well banks 106a, b, c, and d, each having one or more wells 105 located therein. Each of the wells 105 of substrate 100 have channels leading from well 105 to a receiving portion 107 for receiving a microfluidic device and placing the microfluidic device in fluid communication with the plurality of wells via a plurality of channels. The microfluidic device may be a wide range of devices including Topaz® 1.96 and Topaz® 4.96 chips available from Fluidigm Corporation.

FIG. 1B depicts an exploded view of a complete integrated microfluidic device carrier 199 (see FIG. 1C) comprising the components shown in FIG. 1A, and further comprising components that complete the carrier 199 and a microfluidic device 108 which is attached, or more preferably bonded, and yet more preferably directly bonded, preferably without use of adhesives to the microfluidic device receiving portion 107 of substrate 100 as it would be deployed in use of the carrier 199 in a microfluidic system. Within the microfluidic device 108 are one or more channels in fluid communication with one or more vias 114, which in turn provide fluid communication between the channels within the microfluidic device 108 and channels within the substrate 100 which then lead to wells 105 within well rows 106a-d to provide for fluid communication between wells 105 of substrate 100 and the channels within microfluidic device 108.

Accumulator well tops 109 and 110 are attached to accumulator wells 101 and 102 to form accumulator chambers 115 and 116. Accumulator well tops 109 and 110 include valves 112 and 111, respectively, which are preferably check valves for introducing and holding gas under pressure into accumulator chambers 115 and 116. Valves 111 and 112 are situated inside of drywells 102 and 104 to keep liquid, when present in accumulator chambers 115 and 116, from contacting valves 111 and 112. Check valves 111 and 112 are adapted to allow the increase or release of pressure within accumulators 115 and 116, to introduce or remove fluids from accumulators, and also to operate to maintain the pressure within carrier 199, and thus to maintain or apply pressure to appropriate regions of the microfluidic device disposed therein. The advantage of having an “on-board” source of controlled fluid pressure is that the microfluidic device, if actuated by changes in fluid pressure, can be kept in an actuated state independent of an external source of fluid pressure, thus liberating the microfluidic device and carrier from an umbilical cord attached to that external source of fluid pressure. The accumulator may further include a gas pressurization inlet port, a liquid addition port, and a pressurized fluid outlet for communicating fluid pressure to the connection block. Valves 111 and 112 preferably may be mechanically opened by pressing a shave, pin or the like, within a preferred check valve to overcome the self closing force of the check valve to permit release of pressure from the accumulator chamber to reduce the pressure of the fluid contained within the accumulator chamber.

In operation, fluid, preferably gas, is introduced into accumulator chambers 115 and 116 to pressurize accumulator chambers 115 and 116 while a portion of accumulator chambers contain a liquid to create hydraulic pressure. The liquid, under hydraulic pressure, can be in turn used to actuate a deflectable portion, such as a membrane, preferably a valve membrane, inside of microfluidic device 108 by supplying hydraulic pressure through an accumulator outlet (channel 170) that is in fluid communication with accumulator chambers 115 and 116 and at least one channel within microfluidic device 105.

As illustrated, two separate accumulators 115 and 116 are integrated into the carrier. In a preferred use, the second accumulator is used to actuate, and maintain actuation of a second deflectable portion of the microfluidic device, preferably a second deflectable membrane valve. In a particularly preferred embodiment, the first accumulator is used to actuate interface valves within a metering cell, and the second accumulator is used to actuate containment valves within a metering cell, independent of each other. In yet other embodiments, a plurality of accumulators may also be included to provide for independent actuation of additional valve systems or to drive fluid through a microfluidic device.

FIG. 1D depicts a plan view of microfluidic device carrier 199 and wells 105, wherein a port is located adjacent the base of the well, preferably the bottom, or alternatively the side of well 105 for passage of fluid from the well into a channel formed in substrate 100, preferably on the side of substrate 100 opposite of well 105. In a particularly preferred embodiment, substrate 100 is molded with recesses therein, the recesses being made into channels by a sealing layer, preferably an adhesive film or a sealing layer. In accordance with the present invention, substrate 100 and its associated components are fabricated from certain polymers. This aspect of the invention will be described in further detail below.

Accumulator well tops 109 and 110 further may comprise access screws 112 which can be removed to introduce or remove gas or liquid from accumulator chambers 115 and 116. Preferably, valves 112 and 111 can be actuated to release fluid pressure otherwise held inside of accumulator chambers 115 and 116. Notch 117 is used to assist correct placement of the microfluidic device into other instrumentation, for example, instrumentation used to operate or analyze the microfluidic device or reactions carried out therein.

FIG. 1D further depicts a hydration chamber 150 surrounding the microfluidic device receiving portion 107 of the substrate, which can be covered with a hydration cover 151 to form a humidification chamber to facilitate the control of humidity around the microfluidic device 108. Humidity can be increased by adding volatile liquid, for example water, to humidity chamber 151, preferably by wetting a blotting material or sponge. Polyvinyl alcohol may preferably be used. Humidity control can be achieved by varying the ratio of polyvinyl alcohol and water, preferably used to wet a blotting material or sponge. Hydration can also be controlled by using a humidity control device such as a HUMIDIPAK™ humidification package which, for example, uses a water vapor permeable but liquid impermeable envelope to hold a salt solution having a salt concentration suitable for maintaining a desired humidity level. See U.S. Pat. No. 6,244,432 by Saari et al, which is herein incorporated by reference for all purposes including the specific purpose of the disclosure and teaching of humidity control devices and methods. Hydration cover 150 is preferably transparent so as to not hinder visualization of events within the microfluidic device during use. Likewise, the portion of substrate 100 beneath the microfluidic device receiving portion 107 is preferably transparent, but may also be opaque or reflective.

FIG. 1E depicts a plan view of substrate 100 with its channels formed therein providing fluid communication between wells 105 and a microfluidic device 108 (not shown) which is attached to substrate 100 within receiving portion 107, through channels 172. Accumulator chambers 115 and 116 are in fluid communication with receiving portion 107 and ultimately, microfluidic device 108, through channels 170.

FIG. 1F depicts a bottom plan view of substrate 100. In a particularly preferred embodiment, recesses are formed in the bottom of substrate 100 between a first port 190 which passes through substrate 100 to the opposite side where wells 105 are formed and a second port 192 which passes through substrate 100 in fluid communication with a via in microfluidic device 108 (not shown).

FIG. 1G depicts a cross-sectional view of substrate 100 with microfluidic device 108 situated in microfluidic device receiving portion 107 along with sealing layer 181 attached to the side of substrate 100 opposite of microfluidic device 108. Well 105 is in fluid communication with microfluidic device 108 through first port 190, channel 172, and second port 192 and into a recess of microfluidic device 108, which is sealed by a top surface 197 of substrate 100 to form a channel 185. Sealing layer 181 forms channel 172 from recesses molded or machined into a bottom surface 198 substrate 100. Sealing layer 181 is preferably a transparent material, for example, polystyrene, polycarbonate, or polypropylene. In one embodiment, sealing layer 181 is flexible such as in adhesive tape, and may be attached to substrate 100 by bonding, such as with adhesive or heat sealing, or mechanically attached such as by compression. Preferably materials for sealing layer 181 are compliant to form fluidic seals with each recess to form a fluidic channel with minimal leakage. Sealing layer 181 may further be supported by an additional support layer that is rigid (not shown). In another embodiment, sealing layer 181 is rigid.

A thermal transfer interface (not shown) is also provided for use with the carrier in operation. The thermal transfer interface comprises a thermally conductive material disposed to provide substantially homogeneous thermal communication from a thermal control source to a reaction area of the microfluidic device on the carrier. In this manner, thermal energy (e.g., from a PCR machine) can be transmitted to the microfluidic device elastomeric block with minimal or reduced thermal impedance. In some embodiments, the thermal conductive material comprises silicon (Si).

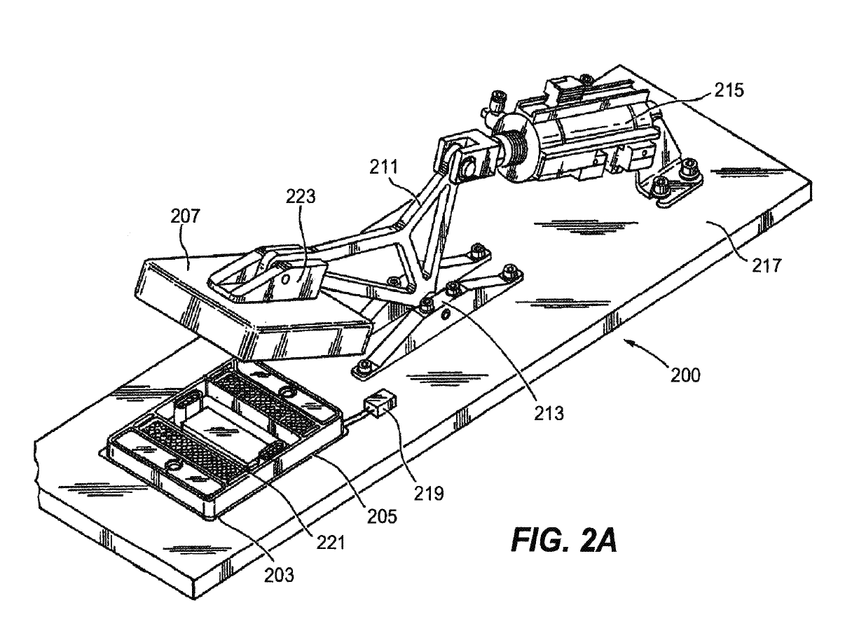

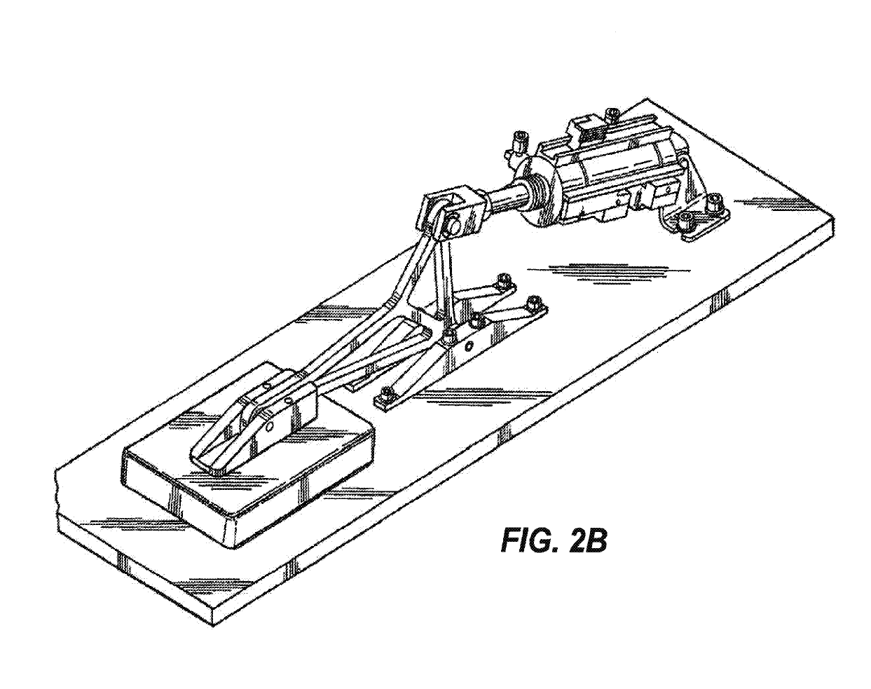

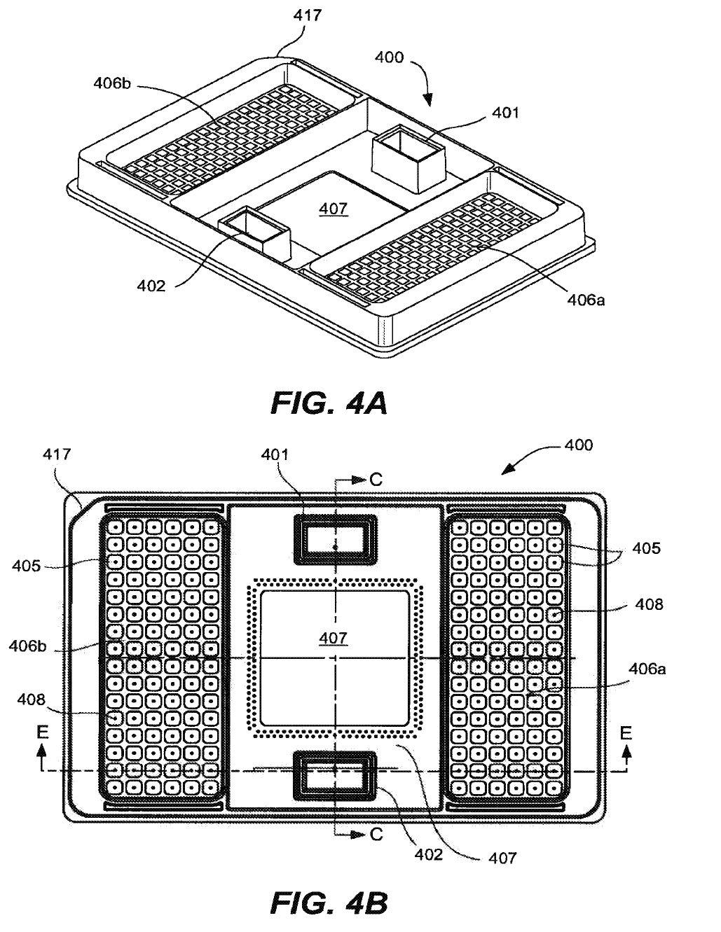

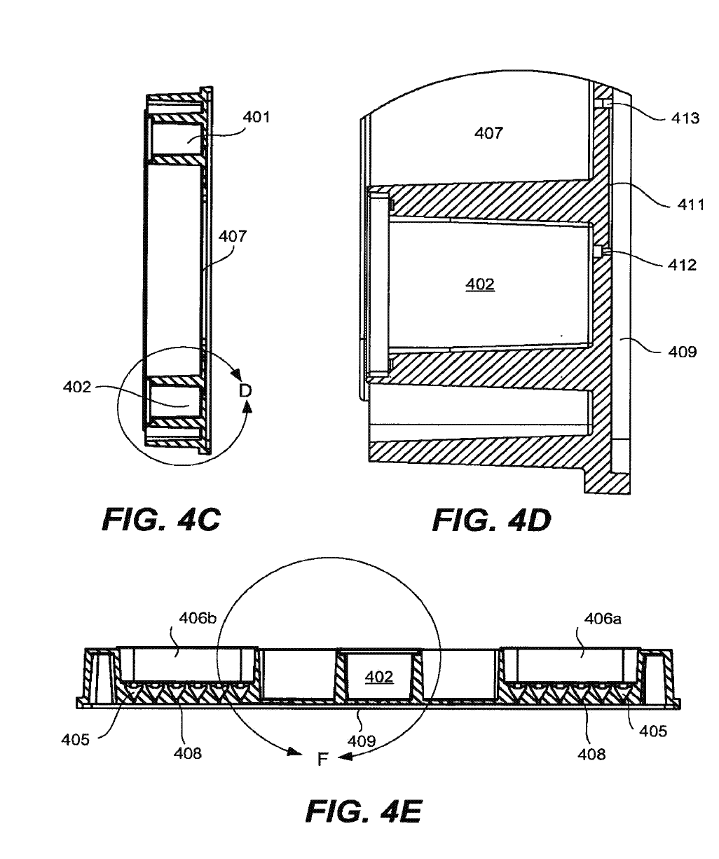

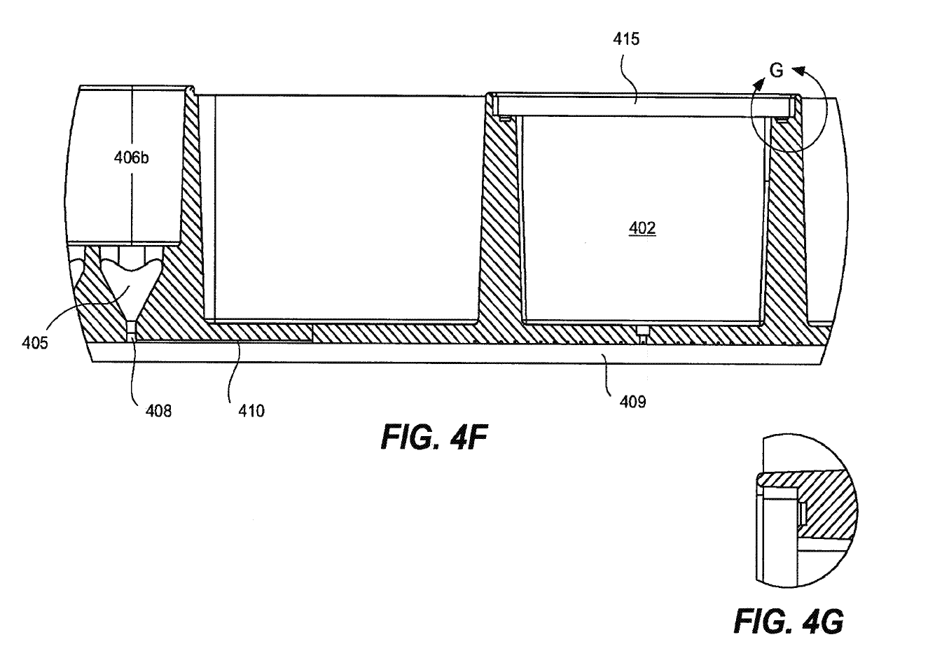

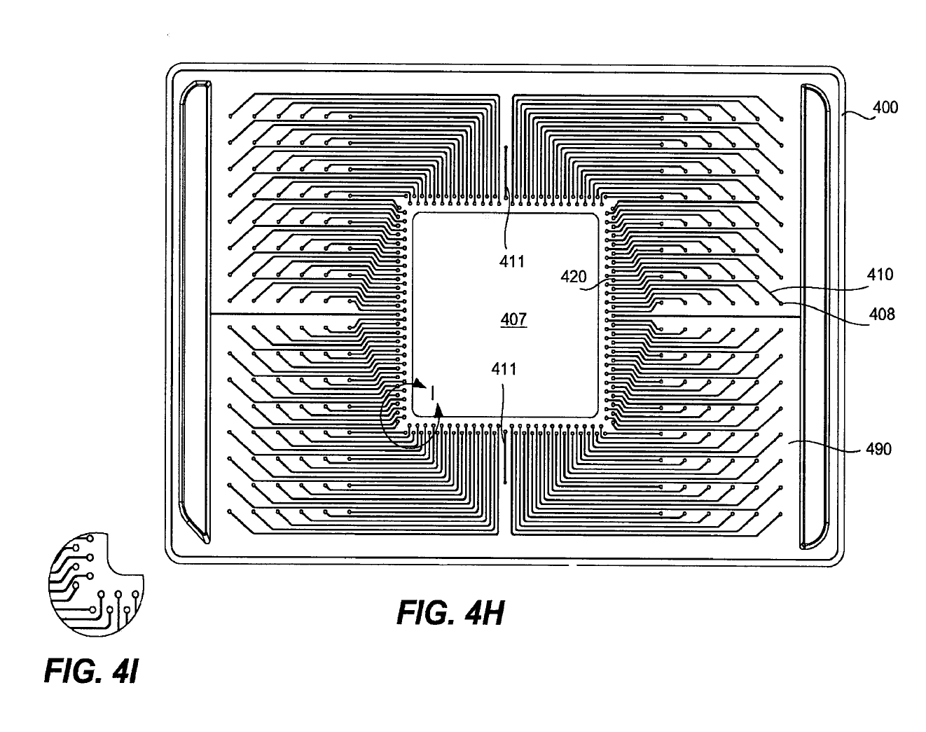

The microfluidic device carriers of the present invention are generally used as part of a system as provided for by the present invention. FIG. 2A depicts a perspective view of a robotic station for actuating a microfluidic device mounted in a carrier in accordance with the present invention. An automated pneumatic control and accumulator charging station 200 includes a receiving bay 203 for holding a microfluidic device carrier 205 of the present invention such as the type depicted in FIGS. 4A-I. A platen 207 is adapted to contact an upper face 209 of microfluidic device 205. Platen 207 has therein ports that align with microfluidic device carrier 205 to provide fluid pressure, preferably gas pressure, to wells and accumulators within microfluidic device carrier 205. In one embodiment, platen 207 is urged against upper face 221 of microfluidic device carrier 205 by movement of an arm 211, which hinges upon a pivot 213 and is motivated by a piston 215 which is attached at one end to arm 211 and at the other end to a platform 217. Sensors along piston 215 detect piston movement and relay information about piston position to a controller, preferably a controller under control of a computer (not shown) following a software script. A plate detector 219 detects the presence of microfluidic device carrier 205 inside of receiving bay 203, and preferably can detect proper orientation of microfluidic device carrier 205. This may occur, for example, by optically detecting the presence and orientation of microfluidic device carrier 205 by reflecting light off of the side of microfluidic device carrier 205. Platen 207 may be lowered robotically, pneumatically, electrically, or the like. In some embodiments, platen 207 is manually lowered to engage carrier 205.

FIG. 2B depicts charging station 200 with platen 207 in the down position urged against upper face 221 of microfluidic device carrier 205, which is now covered by a shroud of platen 207. In one embodiment, fluid lines leading to platen 207 are located within arm 211 and are connected to fluid pressure supplies, preferably automatic pneumatic pressure supplies under control of a controller. The pressure supplies provide controlled fluid pressure to ports within a platen face (not shown) of platen 207, to supply controlled pressurized fluid to microfluidic device carrier 205. Fine positioning of platen 207 is achieved, at least in-part, by employing a gimbal joint 223 where platen 207 attaches to arm 211 so that platen 207 may gimbal about an axis perpendicular to upper face 221 of microfluidic device carrier 205.

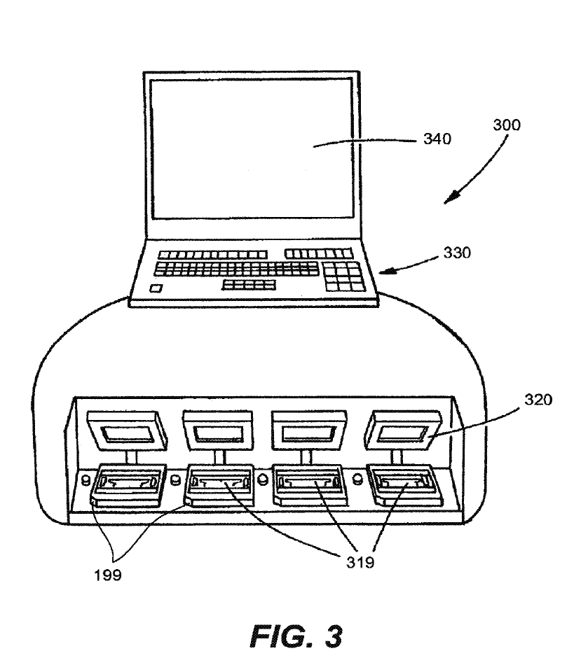

As shown in FIG. 3, a system 300 in accordance with the present invention generally includes one or more receiving stations 310 (such as the robotic stations described with reference to FIGS. 2A-B) each adapted to receive a carrier 199. In a particular embodiment, system 300 includes four (4) receiving stations 310, although fewer or a greater number of stations 310 may be provided. Interface plate 320 is adapted to translate downward so that interface plate 320 engages the upper surface of carrier 199 and its microfluidic device. Interface plate 320 includes one or more ports 325 for coupling with regions in carrier 199 which are adapted to receive fluids, pressure, or the like. System 300 further includes a processor that, in one embodiment, is a processor associated with a laptop computer or other computing device 330. Computing device 330 includes memory adapted to maintain software, scripts, and the like for performing desired processes of the present invention. Further, computing device 330 includes a screen 340 for depicting results of studies and analyses of microfluidic devices. System 300 is coupled to one or more pressure sources, such as a pressurized fluid, gas, or the like, for delivering same to the microfluidic carriers and devices which are fluidly coupled to interface plate(s) 320.

Microfluidic Device Carrier

A microfluidic device carrier in accordance with the present invention incorporates one or more of a variety of aspects to which improved device performance is attributed. The various aspects of the invention will be described with reference to FIGS. 4A-I which illustrate a preferred embodiment of a carrier in accordance with the present invention.

FIGS. 4A and B illustrate, in perspective and in top plan view, a preferred embodiment of a substrate for a microfluidic device carrier in accordance with the present invention in perspective and schematic top plan views, respectively. The carrier substrate 400 has integrated pressure accumulator wells 401 and 402. In the completed carrier, each of the accumulator wells has therein a drywell (not shown) for receiving a valve, preferably a check valve attached to a cover, as described with reference to FIG. 1B, above. Substrate 400 further includes two regions 406a and 406b of 96 wells each. Each of the wells 405 of substrate 400 have channels leading from well 405 to a receiving portion 407 for receiving a microfluidic device and placing the microfluidic device in fluid communication with the plurality of wells via a plurality of channels. The microfluidic device may be a wide range of devices including Topaz® 1.96 and Topaz® 4.96 chips available from Fluidigm Corporation. Notch 417 is used to assist correct placement of the microfluidic device into other instrumentation, for example, instrumentation used to operate or analyze the microfluidic device or reactions carried out therein.

As described with reference to FIG. 1B and C above, in a completed carrier, the accumulator wells 401 and 402 are capped with tops to form accumulator chambers. The accumulator well tops include valves which are preferably check valves for introducing and holding gas under pressure into the accumulator chambers. The valves are situated inside the drywells to keep liquid, when present in the accumulator chambers, from contacting the valves. The check valves are adapted to allow the increase or release of pressure within the accumulators, to introduce or remove fluids from accumulators, and also to operate to maintain the pressure within the carrier, and thus to maintain or apply pressure to appropriate regions of a microfluidic device disposed therein. The advantage of having an “on-board” source of controlled fluid pressure is that the microfluidic device, if actuated by changes in fluid pressure, can be kept in an actuated state independent of an external source of fluid pressure, thus liberating the microfluidic device and carrier from an umbilical cord attached to that external source of fluid pressure. The accumulator may further include a gas pressurization inlet port, a liquid addition port, and a pressurized fluid outlet for communicating fluid pressure to the connection block. The valves preferably may be mechanically opened by pressing a shave, pin or the like, within a preferred check valve to overcome the self closing force of the check valve to permit release of pressure from the accumulator chamber to reduce the pressure of the fluid contained within the accumulator chamber.

In operation, fluid, preferably gas, is introduced into the accumulator chambers to pressurize them while a portion of the accumulator chambers contain a liquid to create hydraulic pressure. The liquid, under hydraulic pressure, can be in turn used to actuate a deflectable portion, such as a membrane, preferably a valve membrane, inside of a microfluidic device mounted on the carrier by supplying hydraulic pressure through an accumulator outlet that is in fluid communication with the accumulator chambers and at least one channel within the microfluidic device.

As illustrated, two separate accumulator wells 401 and 402 are provided to form two separate accumulator chambers integrated into the carrier. In one preferred use, the second accumulator is used to actuate, and maintain actuation of a second deflectable portion of the microfluidic device, preferably a second deflectable membrane valve. In a particularly preferred embodiment, the first accumulator is used to actuate interface valves within a metering cell, and the second accumulator is used to actuate containment valves within a metering cell, independent of each other. In yet other embodiments, a plurality of accumulators may also be included to provide for independent actuation of additional valve systems or to drive fluid through a microfluidic device.

FIGS. 4C and D illustrate details of the structure of the accumulators of the carrier of FIG. 4B. FIG. 4C is a cross-sectional view along C-C showing the profiles of the accumulator wells 401 and 402 and their positioning relative to the microfluidic device receiving portion 407 (also referred to as the chip mounting area) of the carrier. FIG. 4D is an expanded cross-sectional view of a portion D of the substrate 400 showing accumulator well 402 with its dimensions in this embodiment. Accumulator well 402 is in fluid communication with receiving portion 407 and ultimately, microfluidic device (not shown), through channel 411 and ports 412 and 413. In a preferred embodiment, a port 412 is formed from the bottom of substrate 400 and passes through substrate 400 to the opposite side where the well 402 is formed. A second port 413 is formed which passes through substrate 400 into fluid communication with a via in a microfluidic device (not shown) mounted in the receiving portion 407 of the substrate. The two ports 412 and 413 are in fluid communication via the channel 411. In a particularly preferred embodiment, substrate 400 is molded with recesses therein, the recesses being made into channels by a sealing layer, preferably an adhesive film or a sealing layer 409.

The plan view of FIG. 4B and corresponding cross-sectional view along E-E of FIG. 4E depict the microfluidic device carrier substrate 400 and wells 405, wherein a port 408 is located adjacent the base of the well, preferably the bottom, or alternatively the side of well 405 for passage of fluid from the well into a channel 410 formed in substrate 400, preferably on the side of substrate 400 opposite of well 405. FIG. 4F is an expanded cross-sectional view of a portion F of the substrate 400 showing accumulator well 402 with its dimensions in this embodiment. In a particularly preferred embodiment, substrate 400 is molded with recesses therein, the recesses being made into channels by a sealing layer, preferably an adhesive film or a sealing layer 409. Channels 410 formed in the substrate provide fluid communication between wells 405 and a microfluidic device (not /shown) which is attached to substrate 400 within receiving portion 407. FIG. 4G is an expanded cross-sectional view of a portion G of the substrate 400 showing detail of an accumulator well 402.

FIG. 4H depicts a bottom plan view of substrate 400. In a particularly preferred embodiment, channels 410 are formed in substrate 400 between a first port 408 which passes through substrate 400 to the opposite side where wells 405 are formed and a second port 420 which passes through substrate 400 in fluid communication with a via in microfluidic device (not shown) in the receiving portion 407 of the substrate. FIG. 41 is an expanded view of a portion I of FIG. 4H illustrating detail of channels and ports with dimensions in this embodiment.

The channels 410 are preferably formed from recesses molded into a bottom surface 490 substrate 400 being made into channels by a sealing layer, preferably an adhesive film or a sealing layer 409. Sealing layer 409 is preferably a transparent material, for example, polystyrene, polycarbonate, or polypropylene. In one embodiment, sealing layer 409 is flexible such as in adhesive tape, and may be attached to substrate 400 by bonding, such as with adhesive or heat sealing, or mechanically attached such as by compression. Preferably materials for sealing layer 409 are compliant to form fluidic seals with each recess to form a fluidic channel with minimal leakage. Sealing layer 409 may further be supported by an additional support layer that is rigid (not shown). In another embodiment, sealing layer 409 is rigid.

A thermal transfer interface is also provided for use with the carrier in operation. The thermal transfer interface comprises a thermally conductive material disposed to provide substantially homogeneous thermal communication from a thermal control source to a reaction area of the microfluidic device on the carrier. The thermal transfer interface is generally mated against the underside of the microfluidic device. In this manner, thermal energy (e.g., from a PCR machine) can be transmitted to the microfluidic device elastomeric block with minimal or reduced thermal impedance. In some embodiments, the thermal conductive material comprises silicon (Si). In a particular embodiment, silicon from polished and smooth silicon wafers, similar to or the same as that used in the semiconductor industry are used. Other low thermal impedance materials also may be used within the scope of the present invention, depending on the nature of the thermal profiles sought.

In some embodiments, the thermal conductive material has low thermal mass (i.e., materials that effect rapid changes in temperature, even though a good thermal conductor, e.g. copper). In some embodiments, polished silicon is used to enhance mirroring effects and increase the amount of light that can be collected by the detector used in the system, either in real time, or as an end-point analysis of the PCR reaction. These benefits may also improve iso-thermal reactions. In different embodiments, the thermally conductive material may be reflective, may comprise a semiconductor such as silicon or polished silicon, and/or may comprise a metal. In one embodiment, the reaction area is located within a central portion of the microfluidic device and the fluid inlets are disposed at a periphery of the microfluidic device. The microfluidic device may be coupled with the carrier at the periphery of the array device and the thermally conductive material may be coupled with a surface of the array device at the reaction area.

In some embodiments, apparatus is provided for applying a force to the thermal transfer interface to urge the thermal transfer interface towards the thermal control source. The apparatus for applying the force may comprise apparatus for applying a vacuum source towards the thermal transfer interface through channels formed in a surface of a thermal control device or in the thermal transfer device. A vacuum level detector may be provide for detecting a level of vacuum achieved between the surface of the thermal control device and a surface of the thermal transfer device. In one embodiment, the vacuum level detector is located at a position along the channel or channels distal from a location of a source of vacuum.

In one aspect, the carrier substrate 400 is made of an amorphous cyclo-olefin polymer having a tensile elongation at break of at least 10%, for example about 20% (ISO R527). A suitable polymer has dicyclopentadiene and 1,3 pentadiene as monomeric components, for example, a Zeonor™ polymer, available from Zeon Corporation, Tokyo, Japan. A preferred polymer is Zeonor 1420R, the specifications of which are provided herewith, below:

| | Metric | | English | | Comments |
|---|---|---|---|---|---|
| Physical Properties | | | | | |
| Density | 1.01 | g/cc | 0.0365 | lb/in³ | ASTM D792 |
| Water Absorption | <=0.0100% | | <=0.0100% | | ASTM D570 |
| Moisture Vapor Transmission | 0.0870 cc- | | 0.221 cc-mil/ | | g-mm/m²-24 hr; |
| | mm/m²-24 hr-atm | | 100 in²-24 hr-atm | | (300 μm) JIS Z 0208 |
| Linear Mold Shrinkage | 0.00500- | | 0.00500- | | ASTM D955 |
| | 0.00700 cm/cm | | 0.00700 in/in | | |
| Melt Flow | 20.0 g/10 min | | 20.0 g/10 min | | 280° C.; JIS K 6719 |
| Mechanical Properties | | | | | |
| Hardness Rockwell R | 120 | | 120 | | ASTM D785 |
| Tensile Strength, Ultimate | 61.0 | MPa | 8850 | psi | ISO R527 |
| Elongation at Break | 20.0% | | 20.0% | | ISO R527 |
| Tensile Modulus | 2.40 | GPa | 348 | ksi | ISO R527 |
| Flexural Modulus | 2.20 | GPa | 319 | ksi | ASTM D790 |
| Flexural Yield Strength | 94.0 | MPa | 13600 | psi | ASTM D790 |
| Izod Impact, Notched | 30.0 | J/cm | 56.2 | ft-lb/in | ASTM D256 |
| Electrical Properties | | | | | |
| Electrical Resistivity | >=1.00e+16 | ohm-cm | >=1.00e+16 | ohm-cm | ASTM D257 |
| Dielectric Constant | 2.30 | | 2.30 | | 1 MHz; ASTM D150 |
| Dielectric Strength | >=70.0 | kV/mm | >=1780 | kV/in | ASTM D149 |
| Dissipation Factor | 0.000200 | | 0.000200 | | 1 MHz; ASTM D150 |
| Thermal Properties | | | | | |
| CTE, linear 20° C. | 70.0 | μm/m-° C. | 38.9 | μin/in-° F. | JIS K 7197 |
| Maximum Service | 420° | C. | 788° | F. | Thermal Decomposition |
| Temperature, Air | | | | | |
| Deflection Temperature | 136° | C. | 277° | F. | ASTM D648 |
| at 1.8 MPa (264 psi) | | | | | |
| Vicat Softening Point | 145° | C. | 293° | F. | |
| Glass Temperature | 136° | C. | 277° | F. | DSC |
| Optical Properties | | | | | |

| | | | |
|---|---|---|---|
| Refractive Index | 1.53 | 1.53 | ASTM D542 |
| Transmission, Visible | 92.0% | 92.0% | 3 mm; ASTM D1003 |

Advantageously, it has been found that all of the desired features of such a carrier, including wells, channels and ports having smaller dimensions, thinner walls and greater density than previously achieved, can be successfully formed through an injection molding process using such a polymer. It is believed that this polymeric composition reduces or avoids fracturing, so that a carrier substrate in accordance with the present invention can be formed and released from the forming mold without fracturing.

In addition, this selection of polymer composition allows all of the desired features of such a carrier, including the wells, channels and ports to be formed through an injection molding process that avoids the need for a separate drilling of the substrate to from some features. In particular, it has been found necessary to drill port features of previous carriers as these were not reliably rendered by the injection molding process. Thus, a carrier in accordance with this invention can be more efficiently and reliably manufactured than carriers requiring drilling of some features. Also, the surface of the carrier around the perimeter of the receiving area for the microfluidic device is smooth and free of burrs and other surface damage or defects that can result from a process requiring drilling such that adhesion between the carrier and the microfluidic device is not compromised.

In another aspect, the carrier of the invention has a substrate with dimensions of no more than 150 mm length by 100 mm width (e.g., about 125 mm length by 85 mm width), each of the plurality of wells has a well opening with a center point, the plurality of wells is spatially arranged such that the center point to center point spacing is about 4.5 mm, the plurality of wells are arranged in a plurality of rows, and the well rows are divided into a first well region and a second well region, each well region having 96 wells. This is illustrated in FIG. 4B. Prior carriers of this type accommodated arrays of only 48 wells per region (see, for example, FIG. 1A). The carrier of the present invention is able to accommodate double the number of wells (96) per region (406a/406b), resulting in a four-fold increase (48×48=2304 vs. 96×96=9216) in the number of possible combinations of reagents for reaction on a microfluidic device mounted on the carrier. This is accomplished without increasing the footprint of the carrier, so that it remains compatible with the apparatus designed to support the 48×48 well array carrier. And this is achieved while retaining the standard center point to center point well spacing of about 4.5 mm, in accordance with the SBS standard for a 384-well microwell plate standard. Thus, a four-fold throughput increase can be achieved through use of a carrier in accordance with the present invention with a modest adaptation of existing apparatus, resulting in tremendous convenience and savings to users.

The design of the well regions 406a and 406b avoids the formation of sink marks in the carrier during the molding process. A sink mark is a local surface depression that typically occurs in thicker sections of injection molded polymer structures. Carriers in accordance with the present invention are generally manufactured by injection molding. Sink marks are caused by localized shrinkage of the material at thicker sections without sufficient compensation when the structure is cooling because of unbalanced heat removal. After the material on the outside has cooled and solidified, the core material starts to cool. As it does, it shrinks, pulling the surface of the main wall inward, causing a sink mark. Most commonly, sink marks occur on a surface that is opposite to and adjoining a leg or rib. Sink marks can produce warping in a molded structure. In a microfluidic device carrier, warping can interfere with the fluid flow through the fine channels, for example by merging channels, thereby detrimentally impacting the performance of the carrier. The wells 405 in the carrier substrate 400 have a rectangular top profile becoming conical to the bottom of the well. This design reduces the thickness of the walls between the wells and helps avoid sink marks that could result in merged channels (and therefore a defective device) on the back side of the carrier.

In another aspect, illustrated in FIG. 4H, the carrier of the invention has a substrate in which the plurality of channels access the receiving portion 407 for the microfluidic device substantially uniformly around the perimeter of the receiving portion 407. Prior designs limited the channel access to fewer that all sides of the receiving portion 407. This design supports the increased well density on the substrate 400 by making optimal use of the available area on the carrier surface to provide space for all 192 channels connecting the wells 405 to the receiving portion 407, and ultimately the microfluidic device. The increased well density is supported by increased channel 410 density. In one embodiment, the carriers of the present invention support a density of 196 channels 410 that are about 0.1 mm wide and about 0.15 mm deep from the two well regions 406a and 406b accessing the receiving portion 407 which has dimensions of about 35×35 mm. A channel pitch of about lmm has been achieved. This channel density is achieved by using a high tensile elongation at break polymer composition, such as previously described herein.

Also, the pressure accumulator wells 401 and 402 are in fluid communication with the receiving portion 407 for the microfluidic device via a channel 411 that is no more than 20 mm in length, and preferably less than 10 mm in length, as in the specific embodiment shown. This is achieved by reducing the size of the accumulator wells 401 and 402 and positioning them closer to the receiving portion 407, rather than separated from the receiving portion by the well regions as in some previous designs. The smaller accumulators have a smaller footprint so that they occupy less surface area on the carrier and can be positioned closer to the chip. The decreased volume of the smaller accumulators also reduces to time needed to pressurize the accumulators, while still providing adequate capacity to perform their intended function. For example, the accumulators of the carriers of the present invention can have a footprint of no more than 200 cm² and a volume of no more than 2000 cm³, for example a footprint of about 100 to 150 cm² and a volume of about 1000-1500 cm³, or a footprint of about 120 cm² and a volume of about 1200 cm³. Shorter accumulator channel length provides a shorter run for pressurization from the accumulators to the microfluidic device mounted in the receiving potion. This results in more accurate and efficient operation as the pressure drop associated with longer channel flows are avoided.

In another aspect, each of the wells of the carrier of the invention has a depth that is less than half of the height of the carrier. In a specific embodiment, the height of the carrier is no more than 15 mm, and the depth of the wells is no more than 7 mm, for example about 5 mm. The shallower wells have smaller well volumes, meaning that less reagent is needed. Also, reagent is more easily delivered to the bottom of the shallower wells. This reduces and minimizes the amount of often costly reagents and precious, low volume samples required for microfluidic analyses conducted using the carriers of the invention. As noted above with regard to the well regions 406a and 406b, the wells 405 have a rectangular top profile that helps avoid sink marks that could result in merged channels (and therefore a defective device) on the back side of the carrier 400. The shape of the wells 405 is then conical all the way down to the port. This helps guide the tip of the pipette down to the bottom of the well and prevent bubble formation in the dispensed reagent.

These aspects may be implemented alone or in combinations of two or more, up to all of the aspects together in a single carrier.

The various noted features of a carrier in accordance with the invention can be achieved by using a high tensile elongation at break polymer composition such as previously described herein (e.g., Zeonor 1420R) in an injection molding process that uses a hot runner system and a plurality, for example four, of injection ports, rather than a single injection port during the molding process. A suitable hot runner injection molding system is available from, for example, Husky Injection Molding Systems Ltd., Ontario, Canada. In such a system, the temperature of the polymer material can be controlled after it is dispensed from the injection molding machine into the injection molding tool configured to form the carrier. In a suitable process to form a carrier in accordance with the present invention, the polymer is maintained at a relatively high temperature above its melt temperature in the tool until it is injected into the mold for the carrier through multiple gates (injection ports). While a variety of different numbers of gates and positions could be used, a configuration of four gates, each gate positioned near a corner of the carrier mold, for example, has been found to provide good results. The multiple fronts of injected polymer can meet in the mold before the polymer temperature drops below its melt temperature (in the case of Zeonor 1420R, 250-300° C.). In this way, weld lines between the fronts, which could cause weak points, merger and cross-talk between various molded features, are minimized or eliminated, and the various fine features of the carrier described above can be reliably formed in a single injection molding operation without the need for any features (e.g., ports) to be drilled.

Systems

A microfluidic device carrier in accordance with the present invention is usefully adopted in microfluidics systems, as described herein. Thus, a microfluidic system in accordance with the present invention includes an array device for containing a plurality of separate reaction chambers disposed within a reaction area and in fluid communication with fluid inlets to the array device disposed outside the reaction area. The array device comprises an elastomeric block formed from a plurality of layers. At least one layer has at least one recess formed therein. The recess has at least one deflectable membrane integral to the layer with the recess. A carrier in accordance with the present invention is adapted to hold the array device and has a plurality of fluid channels interfaced with the fluid inlets. A thermal transfer interface comprises a thermally conductive material disposed to provide substantially homogeneous thermal communication from a thermal control source to the reaction area. A system and carrier having any one or more of the novel aspects described herein may be interfaced to and used with macroscale systems, such as robotic liquid dispensing systems and control and data processing systems, such as described with reference to FIGS. 2A-B and 3, as will be readily understood to those skilled in the art given the disclosure herein.

### CONCLUSION

Although the foregoing invention has been described in some detail for purposes of clarity of understanding, certain changes and modifications will be apparent to those of skill in the art. It should be noted that there are many alternative ways of implementing both the process and compositions of the present invention. Accordingly, the present embodiments are to be considered as illustrative and not restrictive, and the invention is not to be limited to the details given herein, but may be modified within the scope and equivalents of the appended claims.

1. A method of making a microfluidic device carrier, the method comprising:
forming by an injection molding process in a carrier mold a carrier substrate with a plurality of wells, each well defining a volume of between 0.1 μl and 100 μl;
forming by the injection molding process a plurality of channels within the carrier substrate wherein each well is in fluid communication with at least one of the plurality of channels;
forming by the injection molding process a plurality of ports within the carrier substrate wherein each port is for coupling with regions in the carrier substrate adapted to receive fluids or pressure; and
forming by the injection molding process a receiving portion of the carrier substrate, the receiving portion for receiving a microfluidic device and placing the microfluidic device in fluid communication with the plurality of wells via the plurality of channels;
wherein the carrier substrate is comprised of an amorphous cyclo-olefin polymer having a tensile elongation at break of at least 10%.

2. The method of claim 1, wherein the injection molding process uses a hot runner injection molding system.

3. The method of claim 2, wherein the hot runner injection molding system comprises a plurality of injection ports.

4. The method of claim 3, wherein the hot runner injection molding system comprises four injection ports.

5. The method of claim 4, wherein each injection port is positioned near a corner of the carrier mold.

6. The method of claim 3, wherein the temperature of the polymer is controlled after it is dispensed from the injection molding system into the injection molding tool configured to form the carrier.

7. The method of claim 6, wherein the polymer is maintained at a temperature substantially above its melt temperature in the injection molding system until it is injected into the mold for the carrier through the plurality of injection ports.

8. The method of claim 7, wherein multiple fronts of injected polymer injected via the plurality of injection ports meet in the carrier mold before the polymer temperature drops below its melt temperature.

9. The method of claim 8, wherein the plurality of wells, the plurality of channels and the plurality of ports of the carrier are formed in a single injection molding operation without the need for any drilling.

10. The method of claim 1, wherein the channels are about 0.1 mm wide and about 0.15 mm deep have a channel pitch of about lmm.

11. The method of claim 1, wherein the each of the wells has a depth that is less than half of the height of the carrier substrate.

12. The method of claim 1, wherein the tensile elongation at break of the polymer is about 20%.

13. The method of claim 12, wherein the polymer has dicyclopentadiene and 1,3 pentadiene as monomeric components.

14. The method of claim 1, wherein the volume of the wells is between 0.1 μl and 10 μl.

15. The method of claim 1, wherein the wells are divided into a first well region and a second well region wherein each of the first well region and the second well region have 96 wells.

16. The method of claim 1, wherein the substrate has a length, width and height and dimensions of no more than 150 mm length by 100 mm width, each of the plurality of wells has a well opening with a center point, the plurality of wells is spatially arranged such that the center point to center point spacing is about 4.5 mm, the plurality of wells are arranged in a plurality of rows, and the well rows are divided into a first well region and a second well region, each well region having 96 wells.

17. The method of claim 16, wherein the substrate has dimensions of about 125 mm length by 85 mm width.

18. The method claim 17, wherein the plurality of channels access the receiving portion for the microfluidic device substantially uniformly around the perimeter of the receiving portion.

19. The method of claim 18, wherein the wells have a rectangular top profile becoming conical to the bottom of the wells.

20. A microfluidic device carrier comprising:
a substrate with a plurality of wells, each well defining a volume of between 0.1 μl and 100 μl;
a plurality of channels within the substrate wherein each well is in fluid communication with at least one of the plurality of channels;
a plurality of ports within the carrier substrate wherein each port is for coupling with regions in the carrier substrate adapted to receive fluids or pressure; and
a receiving portion for receiving a microfluidic device and placing the microfluidic device in fluid communication with the plurality of wells via the plurality of channels;
wherein the carrier substrate is comprised of an amorphous cyclo-olefin polymer having a tensile elongation at break of at least 10%; and
wherein the plurality of wells, plurality of channels and plurality of ports in the carrier substrate are formed through an injection molding process.
